(19) United States
(12) Patent Application Publication
(10) Pub. No.: US 2026/0216958 A1
(43) Pub. Date: Jul. 30, 2026

(54) METHOD FOR TREATING THE SURFACE OF A SHAPED PART MANUFACTURED IN AN ADDITIVE METHOD

(71) Applicant: DyeMansion GmbH, Planegg (DE)

(72) Inventors: Fabian Herz, Berg (DE); Alisa Rosenfeld, Stockdorf (DE); Christian Harsch, München (DE); Constanza Oszwald, München (DE); Alena Gleich, Kottgeisering (DE)

(73) Assignee: DyeMansion GmbH, Planegg (DE)

(21) Appl. No.: 19/151,981

(22) PCT Filed: Jan. 30, 2024
(86) PCT No.: PCT/EP2024/052214

§ 371 Date: Jul. 29, 2025

(30) Foreign Application Priority Data
Jan. 30, 2023 (DE) 10 2023 102 179.6

(51) Int. Cl. B29C 64/30; B29C 71/00; B29C 71/02; B29K 77/00; B33Y 40/20

(52) U.S. Cl. CPC B29C 64/30; B29C 71/0009; B29C 71/02; B33Y 40/20; B29K 2077/00

(57) ABSTRACT

A method is provided for treating the surface of a shaped part manufactured in an additive method and to be dyed with a dye, wherein the surface of the shaped part consists at least in portions of a material that has dye binding points, wherein, in a homogenization step, the dye binding points on the surface are at least partially shielded, wherein, as a result of the at least partial shielding of the dye binding points, binding of the dye to the at least partially shielded dye binding points is at least partially prevented. The invention also relates to a dyeing method in which the surface of the shaped part has been treated according to the invention.

### CROSS-REFERENCE TO RELATED APPLICATIONS

This application is a national phase entry of International Application No. PCT/EP2024/052214, filed Jan. 30, 2024, which claims priority to German Patent Application Serial No. DE 10 2023 102 179.6, filed Jan. 30, 2023, the entire disclosures of which are hereby incorporated herein by reference in their entirety.

### FIELD OF THE INVENTION

The invention relates to a method for treating the surface of a shaped part manufactured in an additive method (3D printing method) and to be dyed with a dye.

### BACKGROUND OF THE INVENTION

Shaped parts manufactured additively from a plastics material, such as polyamide materials, are usually dyed with a desired color during post-processing. Anionic acid dyes can be used here. In a dyeing method, the pH value of a dyeing solution is carefully controlled so that the amino groups present in the polyamide are at least partially protonated, and the acid dyes, existing as anions at the adjusted pH value, are attracted to said protonated groups. The protonatable amino groups (or other dye binding points) are therefore crucial for the success and quality of the coloration.

Homogeneous/uniform coloration of the additively manufactured shaped parts is a desired property. It may occur that the coloration of polyamide shaped parts is inhomogeneous, both within a shaped part (mottled or speckled coloration, different coloration of upskin and downskin regions typical of/inherent to 3D printing) and within a dyeing operation (a plurality of shaped parts that are dyed at the same time have different coloration), or across a dyeing run (the shaped parts from a printing operation are dyed in batches and, although the dyeing conditions are the same, the color of the shaped parts varies from batch to batch).

For example, the varying porosity of the material to be dyed on the surface of the shaped part as a result of the manufacturing process can influence the uniformity of the coloration. The porosity can be largely homogenized by blasting or compacting the surface, which ensures more even penetration of the dye, which in turn leads to more homogeneous coloration.

It is known from WO 2015 124 639 A1 that the uniformity of the coloration can be improved by prior blasting of the components.

It is known from WO 2021 014 004 A1 to improve the uniformity of the coloration by adding quaternary ammonium salts to the dyeing solution.

However, it has been shown that uniform coloration cannot always be achieved or cannot be achieved sufficiently by prior blasting of the surface or by adding quaternary ammonium salts to the dyeing solution.

### OBJECT OF THE INVENTION

The object of the present invention is therefore to provide a method for treating the surface of a shaped part manufactured in an additive method, which method allows for a better, in particular more homogeneous, coloration of the surface of the shaped part.

### SUMMARY OF THE INVENTION

This object is achieved by a method for treating the surface of and by a method for dyeing shaped parts manufactured in an additive method according to the independent claims. Advantageous embodiments are specified in the corresponding dependent claims.

Accordingly, a method is provided for treating the surface of a shaped part manufactured in an additive method and to be dyed with a dye, wherein the surface of the shaped part consists at least in portions of a material that has dye binding points, wherein, in a homogenization step, the dye binding points on the surface are at least partially shielded, wherein, as a result of the at least partial shielding of the dye binding points, binding of the dye to the at least partially shielded dye binding points is at least partially prevented.

This means that the dye binding points are at least partially shielded during the dyeing with the dye.

It is advantageous if the partial shielding of the dye binding points causes the dye binding points to appear more homogeneous overall on the surface, whereby the dye is bound more homogeneously.

In one embodiment of the invention, the dye binding points can be at least partially shielded by bringing the surface into contact with a shielding agent, wherein the shielding agent is selected to be adapted to at least partially prevent the binding of the dye to the dye binding points.

It is advantageous if the shielded dye binding points are amino groups.

The shielding agent can be selected to be adapted to at least partially prevent the protonation of the free amino groups.

The shielding agent can be selected such that the binding of the shielding agent to the dye binding points shielded by the shielding agent is stronger than that of the dye to the dye binding points. The shielding agent is therefore selected such that it cannot be displaced by the dye during the dyeing with the dye.

It is advantageous if the shielding agent is selected from the group comprising ketones, aldehydes, lactones, lactams, nitriles, isonitriles, nitro compounds, carboxylic acids and carboxylic acid derivatives, urea and urea derivatives, sulfoxides, sulfones, sulfonic acids, carbonic acid esters, inorganic acids, anhydrides of inorganic acids, alcohols, amines, amides, acetals, hemiacetals, and combinations and mixtures thereof.

The shielding agent can further be selected from the group comprising compounds reactive toward amino groups, preferably carboxylic acid anhydrides, most preferably acetic anhydride.

In one embodiment of the invention, the shielding agent can be heated to a predetermined temperature and brought into contact with the surface for a predetermined period of time.

An additive, in particular a solvent, a catalyst, a base or an activating agent, can be added to the shielding agent.

The shielding of the dye binding points can comprise thermally treating at least the portions of the surface of the shaped part comprising the material.

The thermal treatment can comprise that the portions of the surface of the shaped part comprising the material are heated and cooled in a controlled manner, whereby more dye binding points are present in the crystalline regions of the surface than before, and/or the dye binding points are distributed more homogeneously on the surface overall.

The controlled heating can comprise heating for a predetermined period of time to a material-dependent predetermined temperature, preferably between the recrystallization temperature and, at most, the melting temperature, and the controlled cooling can comprise a defined cooling rate and/or reaching a material-dependent predetermined temperature, preferably below the recrystallization temperature.

The material can comprise a plastics material, in particular a polymer.

In one embodiment of the invention, the thermal treatment of the surface can be carried out before and/or after bringing the surface into contact with a shielding agent.

A dyeing method is also provided, comprising the following steps:
providing a shaped part manufactured in an additive method, wherein the surface of the shaped part consists at least in portions of a material containing dye binding points;
carrying out a surface treatment step for treating the surface of the shaped part according to the aforementioned method;
carrying out a dyeing step for dyeing at least the surface of the shaped part treated in the surface treatment step, with one or more dyes.

The surface treatment step and the dyeing step can be carried out immediately one after the other.

### BRIEF DESCRIPTION OF THE DRAWINGS

Further details and features of the invention will become apparent from the following description taken in conjunction with the drawings. In the figures:

FIG. 1 is a sketch to illustrate chemical shielding; and

FIG. 2 is a sketch to illustrate physical shielding.

### DETAILED DESCRIPTION OF THE INVENTION

The core of the invention is to at least partially shield free dye binding points that are accessible to the dye on the surface of the shaped part to be dyed. Dye binding points can be chemical in nature (functional groups such as amino groups or acid groups, or surface portions such as aliphatic chains) and/or physical in nature (cavities, pores). In the context of the present invention, shielding means reducing the affinity of the dye for the dye binding point or making the dye binding point less accessible to the dye. By partially shielding the free dye binding points, binding of the dye to the shielded dye binding points is at least partially prevented. The shielding ensures that all dye binding points are preferably equally accessible or equally difficult to access for the dye. The dye binding points therefore appear more homogeneous overall on the surface of the shaped part, whereby the dye is bound more homogeneously, which leads to significantly more homogeneous coloration of the shaped part.

Surprisingly, the inventors discovered that partially shielding the free dye binding points responsible for the coloration can significantly improve the homogeneity of the coloration.

The inventors discovered that partial shielding of the free dye binding points can be achieved both chemically and physically. Both chemical and physical shielding are based on the same core idea of the invention, namely to make free dye binding points on the surface of the shaped part at least partially inaccessible to the dye.

The method according to the invention described below is in particular suitable for additively manufactured shaped parts that have been manufactured in the SLS (selective laser sintering) method, MJF (Multi Jet Fusion) method, HSS (high speed sintering) method, SAF (selective absorption fusion) method, FDM (fused deposition modeling) method, and SLA (stereolithography) method. The method according to the invention is particularly advantageous for shaped parts that have been manufactured in a powder-based layer construction, in which individual layers are fused together, such as the SLS method, since the components are often exposed to uncontrollable thermal loads in these powder-based methods. Therefore, the number and distribution of dye binding points are uncontrollably varied, leading to inhomogeneous coloration.

For the manufacture of the shaped part in the additive method, the material of the shaped part can be selected from the group comprising aliphatic, semi-aromatic and aromatic polyamides, in particular polyamide 6 (PA6), polyamide 6.6 (PA6.6), polyamide 11 (PA11 ), polyamide 12 (PA12 ), polyamide 4.6 (PA4.6), polyamide 6.12 (PA6.12), polyphthalamides (PPA), thermoplastic co-polyamides, thermoplastic polyether polyamides (TPA) and other polyamide-based block polymers, as well as copolymers, blends and mixtures of polyamides with other materials, for example with metal powders (alumides) and/or with other particles (for example with glass, ceramics) and/or additives (for example with antioxidants, antistatic agents, flow agents, brighteners).

However, other materials can also be used, provided they are suitable for a 3D printing method and have dye binding points that can be shielded according to the invention, for example methacrylates having free amino groups in the substituent.

The dye is selected from the group comprising metal complex dyes, acid dyes, reactive dyes, azo dyes, disperse dyes, and mixtures thereof.

### Partial Chemical Shielding of the Free Dye Binding Points:

In chemical shielding, the free dye binding points are at least partially shielded by bringing the surface of the shaped part into contact with a chemical shielding agent. The shielding agent is selected to be adapted to at least partially prevent the dye from binding to the dye binding points. This can occur either covalently or through non-covalent (e.g., ionic or van der Waals) bonds. An advantageous shielding agent is therefore preferably selected from the group comprising compounds reactive toward dye binding points. In this case, the dye binding points can comprise amino groups, which are at least partially shielded by the shielding agent.

For example, the surface of the shaped part manufactured from polyamide can be brought into contact with acetic anhydride. The amino groups are at least partially acetylated. Protonation of the free amino groups during the dyeing step is thus at least partially prevented, making them inaccessible to the dye. For surfaces of shaped parts modified in this way, the qualitative ninhydrin test was carried out, indicating the reduced number of amino groups.

The shaped parts treated in this way could then be dyed without restriction using known dyeing methods, wherein it was possible to achieve greatly improved homogeneity of the coloration compared to untreated shaped parts (not treated according to the method according to the invention).

It can be advantageous if the shielding agent is selected such that the binding of the shielding agent to the dye binding points shielded by the shielding agent is stronger than that of the dye to the dye binding points.

Suitable shielding agents are shielding agents selected from the group comprising ketones, aldehydes, lactones, lactams, nitriles, isonitriles, nitro compounds, carboxylic acids and carboxylic acid derivatives, urea and urea derivatives, sulfoxides, sulfones, sulfonic acids, carbonic acid esters, inorganic acids, anhydrides of inorganic acids, alcohols, amines, amides, acetals, hemiacetals, isocyanates, and combinations thereof.

Polymers and polymer-like compounds containing functional groups that are reactive toward dye binding points (e.g., sulfonated polymers) can also be used as shielding agents.

Suitable shielding agents also include shielding agents from the group of polymerization chain terminators (for polyamides, for example, from the group comprising acids and lactones) as well as compounds that can attach protecting groups to the particular dye binding point. Such protecting groups attached to the dye binding points can then be removed again as needed after dyeing by suitable deprotection methods in order to expose the dye binding points again, e.g., to make them accessible for further functionalization.

Alternatively, a shielding agent can also be generated in-situ or activated with an activating agent; for example, an activated acid can be produced in-situ with a carbodiimide-based activating agent (dicyclohexylcarbodiimide or diisopropylcarbodiimide).

An advantageous shielding agent for polyamides is selected from the group comprising compounds reactive toward amino groups, preferably carboxylic acid anhydrides. Particularly advantageous shielding agents are acetic anhydride and propionic anhydride.

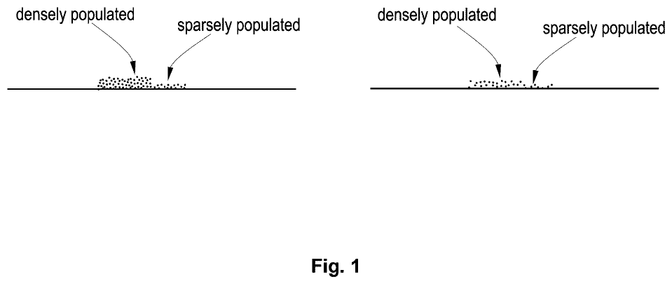

FIG. 1 shows, in a highly schematic manner, the mode of operation of the method according to the invention according to the partial chemical shielding of the free dye binding points.

The accumulation of free dye binding points or free amino groups (left) on the surface of the shaped part as a result of the manufacturing process leads to darker colored areas and a pronounced visual contrast (i.e., to a significant inhomogeneity in the coloration) compared to a “lesser” accumulation of free dye binding points or free amino groups (right) on the surface of the shaped part.

A simplified exemplary example: Suppose there are 500 free amino groups at a “densely populated” point and 50 free amino groups at a “sparsely populated” point (left image in FIG. 1). The high contrast (and thus the visible inhomogeneity) is due to the difference in the free amino groups (the difference in this example is 450 free amino groups). For example, if 60% of the free amino groups are shielded (right image in FIG. 1), then 200 free amino groups at the “densely populated” point and 20 free amino groups at the “sparsely populated” point remain for dyeing. By partially shielding the free amino groups, the contrast is reduced to only 180 free amino groups compared to 450 free amino groups before shielding, which allows for considerably more homogeneous coloration.

A significant advantage of the method according to the invention is that, by partially shielding the free dye binding points or free amino groups, the shaped parts have a highly homogeneous surface, which allows for highly homogeneous coloration in a subsequent dyeing step.

In one embodiment of the invention, the partial shielding of the free dye binding points or free amino groups can also be carried out immediately before the dyeing step, preferably in the same device, for example in the same bath. For example, the component can be brought into contact with a shielding agent according to the method according to the invention, whereupon the dye, including additives, is dosed directly into the shielding agent. It is advantageous if the dye is soluble in the shielding agent or in the solution of the shielding agent. If the dye is poorly soluble, solubilizers can be added.

This means that the method according to the invention ensures that the dyes are absorbed equally well over the entire surface.

Experiments have shown that shaped parts treated using the method according to the invention and dyed shaped parts have more homogeneous coloration than untreated shaped parts or shaped parts treated using the methods described above:
A highly homogeneous coloration is achieved within the component (significantly less mottled, color balance between upskin and downskin regions).
Within a dyeing process, the color differences between a plurality of components dyed at the same time are significantly diminished.
Within a dyeing run, the color differences between the components manufactured in one printing operation but dyed in a plurality of consecutive batches are significantly diminished.

The problem of different dyeability of the upskin and downskin regions is typical and unique to the field of 3D printing.

Experiments have shown that, with the method according to the invention, homogenized surfaces can be produced and dyed that practically do not differ from surfaces of shaped parts that are manufactured by injection molding.

In the context of the present invention, contacting the shaped part with the shielding agent can mean that part or all of the shaped part is brought into contact with the shielding agent. In this case, contacting means that the shielding agent can be present in different aggregate states. Advantageously, the shielding agent is in a liquid state. Preferably, the shaped part is contacted with the shielding agent by immersion, vapor deposition, or spraying. Autoclaves, immersion baths, drip devices, spraying systems, immersion systems, flow-coating systems, vapor-smoothing systems, nebulizing nozzles, atomizers, and other spray devices, among others, can be used for this purpose.

An increased temperature can advantageously accelerate the shielding reaction.

Alternatively, the shielding agent can be dissolved in a suitable solvent. Alternatively, the shielding agent can be added to the solvent (dropwise), e.g., if the shaped parts are already immersed in the solvent. Alternatively, other auxiliaries can be dissolved in the shielding agent and/or solvent, such as acid scavengers (e.g., a strong inorganic base such as sodium hydroxide).

If the shielding agent is gaseous or if the shielding agent is used at a temperature above the boiling point of the shielding agent, it can also be mixed with a suitable carrier gas, for example nitrogen or argon.

After the homogenization step, the surface of the shaped part is preferably completely freed of excess shielding agent. For this purpose, the shaped part is preferably washed and dried. Drying can be carried out by air-drying or by means of a stream of air/gas. An increased temperature and/or reduced pressure/vacuum can accelerate drying. Chemical shielding can thus be combined with physical shielding as needed, provided that drying is achieved by heating after chemical shielding.

The process conditions for shielding can be adjusted depending on the particular shaped part, the dye used, or the color to be achieved.

### Example 1

Additively manufactured test specimens made of PA2200 were mixed with 25 ml of acetic anhydride in a beaker. Then 0.5 g of NaOH dissolved in 3 ml of deionized water was added. The test specimens were incubated with stirring at 50° C. for 3 h and then washed thoroughly with water. For monitoring the reaction, the ninhydrin test was carried out on a “sacrificial test specimen” (a drop of fresh 0.5% (w/w) ninhydrin solution in i-propanol was added to a test specimen heated to 90° C. and treated and was incubated for 10 min at 90° C.; the absence of the blue coloration indicated the substantially complete deactivation, i.e., shielding, of the amino groups). The treated test specimens were then dyed together with untreated test specimens (not treated according to the method according to the invention) with an aqueous dye solution (red dye) in an immersion bath. The resulting color effect of the treated test specimens was demonstrated by a significantly less mottled and significantly more homogeneously colored surface compared to the untreated test specimens.

### Example 2

A plurality of test specimens (each made of PA2200) printed in the “sweet spot” were placed in a beaker with 25 ml of acetic anhydride. Then 0.5 g of NaOH dissolved in 3 ml of deionized water was added. The test specimens were incubated with stirring at 50° C. for 3 h and then washed thoroughly with water. The treated test specimens were then dyed together with untreated test specimens (not treated according to the method according to the invention) printed in the “sweet spot,” with an aqueous dye solution (brown dye) in an immersion bath. Both the treated and untreated test specimens had minor color differences among themselves, wherein the treated test specimens had an even more homogeneous coloration. This means that it was possible to further homogenize even the surface of the sweet spot test specimens, which were already printed under relatively good thermal control, using the method according to the invention.

Surprisingly, it has been found that the partial chemical shielding of the free dye binding points achieves both an increased homogeneity of the coloration and an effective protection against yellowing. The shaped parts treated using the method according to the invention thus yellow significantly less than the untreated shaped parts. This effect can be enhanced by using a deactivating agent that also contains UV-absorbing groups (e.g., phenyl groups in mellitic acid). This effect is particularly advantageous for shaped parts that are chemically smoothed before dyeing, because experience has shown that chemically smoothed shaped parts yellow more quickly than non-chemically smoothed shaped parts. This advantageously increases the stability of both undyed and dyed shaped parts. This eliminates the need for vacuum packaging and storage under the exclusion of light, which are typically necessary for long-term storage of additively manufactured shaped parts.

Accordingly, a method is also provided for treating the surface of a shaped part manufactured in an additive method, wherein the surface of the shaped part consists at least in portions of a material that contains dye binding points, wherein, in a homogenization step, the dye binding points on the surface are at least partially shielded, wherein, as a result of the at least partial shielding of the dye binding points, yellowing of the surface of the shaped part is at least partially prevented.

### Partial Physical Shielding of the Free Dye Binding Points

Alternatively or in addition to the chemical shielding described above, the dye binding points on the surface of the shaped parts can also be at least partially physically shielded. For this purpose, the surface of the shaped part is thermally treated according to the invention and thus thermally homogenized, which also leads to a significantly more homogeneous coloration of the surface in a subsequent dyeing step.

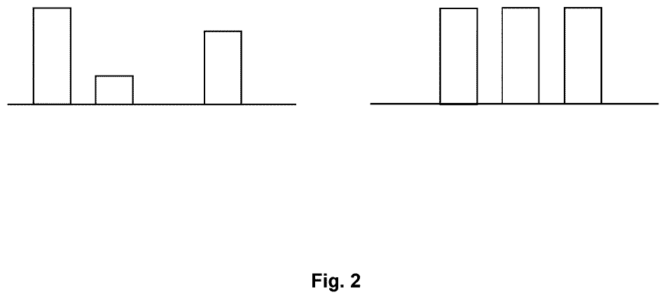

FIG. 2 shows, in a highly schematic manner, the mode of operation of the method according to the invention according to the partial physical shielding of the free dye binding points.

It has been shown that the crystallinity of the surface of the shaped part influences the dyeability of the shaped part. If the degree of crystallinity is the same and the lateral distribution of the crystalline regions is homogeneous (right image of FIG. 2), homogeneous coloration is possible. The method according to the invention achieves a largely uniform degree of crystallinity and a homogeneous distribution of crystallinity on the surface of the shaped part, which allows for more homogeneous coloration of the surface.

For this purpose, the shaped part or the surface of the shaped part is heated and then cooled (thermally treated), whereby more dye binding points are present in the crystalline regions of the surface than before the thermal treatment and the dye binding points are distributed more homogeneously on the surface overall. Thermal treatment preferably reduces the ratio of amorphous components to crystalline components.

Preferably, the surface is heated and cooled in a controlled manner.

Heating is carried out to a predetermined material-dependent temperature for a predetermined period of time, which material-dependent temperature is preferably between the recrystallization temperature and the melting temperature of the material of the shaped part.

In one embodiment of the invention, heating is carried out to a predetermined material-dependent temperature for a predetermined period of time, which material-dependent temperature is preferably between the glass transition temperature and the melting temperature of the material of the shaped part.

The heating rate can be constant or vary over time. For example, the heating rate can be from 0.5° C./min to approximately 100° C./min.

The appropriate temperature can be derived from the DSC curve of the powder used.

Preferably, the component is heated at least until the component is heated throughout to the predetermined material-dependent temperature.

Cooling takes place at a predetermined cooling rate and/or until a material-dependent predetermined temperature is reached, which is preferably below the recrystallization temperature / recrystallization range.

In one embodiment of the invention, cooling takes place at a predetermined cooling rate and/or until a material-dependent predetermined temperature is reached, which is preferably below the glass transition temperature. The cooling rate can be constant or vary over time. For example, the cooling rate can be from 0.5° C./min to approximately 100° C./min.

In one embodiment of the invention, the heating and cooling rates, as well as the temperatures reached, can also be selected such that the ratio of amorphous to crystalline increases. A more homogeneously amorphous component can also be dyed more homogeneously.

Additively manufactured PA2200 test specimens were kept at 160° C. for 8 h (heating rate 1° C./min), and then cooled for 5 min at 0° C. The treated test specimens were then dyed together with untreated test specimens (not treated according to the method according to the invention) with an aqueous dye solution (red dye) in an immersion bath. The resulting color effect of the treated test specimens was demonstrated by a significantly less mottled and significantly more homogeneously colored surface compared to the untreated test specimens.

In the context of the present invention, heating the shaped part can mean that part or all of the shaped part is heated.

Advantageously, the shaped part is heated in an inert environment (for example, in a vacuum, in a protective gas atmosphere, or in an inert silicone oil). Heating can be carried out both contact-free or indirectly (e.g., via microwaves) and directly (e.g., via a heat transfer medium).

Autoclaves, immersion baths (with oil, silicones, glycerin as a heat transfer medium), hot plates, heat lamps, heated air and gas streams, drying ovens, furnaces, vacuum furnaces, induction furnaces, and induction plates, IR emitters, microwave systems, hot air guns and blowers, among others, can be used for this purpose.

The heating methods can be combined, e.g., carried out simultaneously or sequentially.

If there is a risk that the geometry of the shaped part will be changed by heating, means can also be used to counteract the change in geometry (e.g., support structures, the supporting heat transfer medium, the reversibly gelable gel, which can act as a heat transfer medium).

Cooling is preferably carried out using an ice bath. Alternatively, refrigerators and other refrigerating machines and cooling elements, air/gas flows, cold-air blowers and fans, cooling mixtures and cooling media (in particular liquid nitrogen), Peltier devices, among others, can be used. The shaped part can also be cooled without external intervention through the thermodynamically favored radiation of heat.

Before the surface of a shaped part manufactured in a 3D printing method is treated according to the invention, the shaped part can be mechanically processed, for example blasted, in order to remove excess powder, for example. In addition, the shaped parts can preferably be blasted with plastics material balls before or after the treatment according to the invention, in order to achieve compacting of the surface. It is advantageous here if the plastics material balls have a similar or even a lower degree of hardness than the material of the shaped part; this ensures that the surface is compacted without damaging the surface.

In one embodiment of the invention, the shaped parts can be smoothed before or after the treatment according to the invention, in particular chemically and/or by grinding. The yellowing of the surface can be significantly reduced or avoided by the treatment according to the invention after chemical smoothing.

In one embodiment of the invention, the shaped parts can, prior to chemical smoothing and either outside or inside a smoothing chamber, be heated, preferably in a controlled manner (i.e., depending on material properties, geometric data, and/or in-situ via thermal measurement), which heating is followed by chemical smoothing, which is in turn followed by physical shielding / post-drying (combined with the drying step to remove any residual solvent remaining in the shaped parts) and then by subsequent dyeing. Post-drying preferably takes place below the melting point of the shaped part, for PA12 preferably at 160° C., and can take place outside or inside the smoothing chamber. The amount of residual solvent can be monitored and measured in such a process, and the process management (e.g., time, temperature, heating rate) of the combined drying and physical shielding step can thus be controlled and optimized. The sequence of steps of preheating-smoothing physical shielding/post-drying-dyeing can shorten the overall post-processing time and significantly improve the quality of the subsequent coloration. In this embodiment of the invention, any residual solvent can act as a plasticizer, thereby facilitating physical shielding. The surface of the shaped part is melted evenly and then cooled homogeneously so that the crystalline phase can form evenly on the surface.

In one embodiment of the invention, the shaped parts can be impregnated and/or painted after the treatment according to the invention.

In one embodiment of the invention, the shaped parts can be matted, in particular by blasting the surface.

In one embodiment of the invention, the shaped parts can be functionalized before, during, or after the treatment according to the invention, in order to impart useful functional properties to the surface, for example ESD safety or improved mechanical properties.

Optionally, the surface of the shaped part can be heated in a furnace or a vacuum furnace before and/or after the treatment according to the invention.

Optionally, the shaped part can be cleaned in a cleaning bath at a predetermined temperature before and/or after the treatment according to the invention.

According to the invention, the optional pre-and post-treatment steps can be combined in any order.

We claim:

1. A method for treating the surface of a shaped part manufactured in an additive method and to be dyed with a dye, wherein the surface of the shaped part consists at least in portions of a material that has dye binding points, wherein, in a homogenization step, the dye binding points on the surface are at least partially shielded, wherein, as a result of the at least partial shielding of the dye binding points, binding of the dye to the at least partially shielded dye binding points is at least partially prevented.

2. The method according to claim 1, wherein the partial shielding of the dye binding points causes the dye binding points to appear more homogeneous overall on the surface, whereby the dye is bound more homogeneously.

3. The method according to claim 1, wherein the dye binding points are at least partially shielded by bringing the surface into contact with a shielding agent, wherein the shielding agent is selected to be adapted to at least partially prevent the binding of the dye to the dye binding points.

4. The method according to claim 1, wherein the shielded dye binding points are amino groups.

5. The method according to claim 3, wherein the shielding agent is selected to be adapted to at least partially prevent protonation of the free amino groups.

6. The method according to claim 3, wherein the shielding agent is selected such that the binding of the shielding agent to the dye binding points shielded by the shielding agent is stronger than that of the dye to the dye binding points.

7. The method according to claim 3, wherein the shielding agent is selected from a group consisting of: ketones, aldehydes, lactones, lactams, nitriles, isonitriles, nitro compounds, carboxylic acids and carboxylic acid derivatives, urea and urea derivatives, sulfoxides, sulfones, sulfonic acids, carbonic acid esters, inorganic acids, anhydrides of inorganic acids, alcohols, amines, amides, acetals, hemiacetals, and combinations and mixtures thereof.

8. The method according to claim 3, wherein the shielding agent is selected from a group consisting of compounds reactive toward amino groups, preferably carboxylic acid anhydrides, most preferably acetic anhydride.

9. The method according to claim 3, wherein the shielding agent is heated to a predetermined temperature and brought into contact with the surface for a predetermined period of time.

10. The method according to claim 3, wherein an additive, in particular a solvent, a catalyst, a base or an activating agent, is added to the shielding agent.

11. The method according to claim 1, wherein the shielding of the dye binding points comprises thermally treating at least the portions of the surface of the shaped part comprising the material.

12. The method according to claim 11, wherein thermally treating at least the portions of the surface comprises heating and cooling the portions of the surface of the shaped part comprising the material in a controlled manner, whereby more dye binding points are present in crystalline regions of the surface than before, and/or the dye binding points are distributed more homogeneously on the surface overall.

13. The method according to claim 12, wherein the controlled heating comprises heating for a predetermined period of time to a material-dependent predetermined temperature, preferably between a recrystallization temperature and, at most, a melting temperature of the material, and
wherein the controlled cooling comprises cooling the material at a defined cooling rate and/or cooling the material to a material-dependent predetermined temperature, preferably below the material's recrystallization temperature.

14. The method according to claim 1, wherein the material comprises a plastics material, in particular a polymer.

15. The method according to claim 11, wherein the thermal treatment of the surface is carried out before and/or after bringing the surface into contact with a shielding agent.

16. A dyeing method comprising the following steps:
providing a shaped part manufactured in an additive method, wherein the surface of the shaped part consists at least in portions of a material containing dye binding points;
carrying out a surface treatment step for treating the surface of the shaped part according to the method according to claim 1;
carrying out a dyeing step for dyeing at least the surface of the shaped part treated in the surface treatment step, with one or more dyes.

17. The dyeing method according to claim 16, wherein the surface treatment step and the dyeing step are carried out immediately one after the other.
